(19) United States
(12) Patent Application Publication
(10) Pub. No.: US 2025/0300795 A1
(43) Pub. Date: Sep. 25, 2025

(54) METHODS FOR UE CONFIGURATION AND SCHEDULING IN SUBBAND-FULLDUPLEX NETWORK

(71) Applicant: MediaTek Singapore Pte. Ltd., Singapore (SG)

(72) Inventors: Jozsef Gabor NEMETH, Cambridge (GB); Timothy James FROST, Oulu (FI); Mohammed S Aleabe AL-IMARI, Cambridge (GB); Lung-Sheng TSAI, Hsinchu City (TW); Francesc BOIXADERA-ESPAX, Cambridge (GB); Chiou-Wei TSAI

(21) Appl. No.: 18/860,203

(22) PCT Filed: May 5, 2023
(86) PCT No.: PCT/CN2023/092328

§ 371 Date: Oct. 25, 2024

Related U.S. Application Data
(60) Provisional application No. 63/338,909, filed on May 6, 2022.

(51) Int. Cl. H04L 5/14; H04L 5/00; H04L 27/26

(52) U.S. Cl. CPC H04L 5/14; H04L 5/0044; H04L 5/0098; H04L 27/2656

(57) ABSTRACT

Techniques pertaining to user equipment (UE) configuration and scheduling in subband-fullduplex (SBFD) networks are described. A UE receives a configuration in a SBFD radio access network (RAN). The UE then applies the configuration. In an event that the configuration comprises a downlink (DL) or uplink (UL) cluster configuration, the UE applies the DL or UL cluster configuration to a set of groups of resource blocks (RBs).

### CROSS REFERENCE TO RELATED PATENT APPLICATION(S)

The present disclosure is part of a non-provisional application claiming the priority benefit of U.S. Patent Application No. 63/338,909, filed 6 May 2022, the content of which herein being incorporated by reference in its entirety.

### TECHNICAL FIELD

The present disclosure is generally related to mobile communications and, more particularly, to techniques for user equipment (UE) configuration and scheduling in subband-fullduplex (SBFD) networks.

### BACKGROUND

Unless otherwise indicated herein, approaches described in this section are not prior art to the claims listed below and are not admitted as prior art by inclusion in this section.

In wireless communications, such as mobile communications under the 3rd Generation Partnership Project (3GPP) specification(s) for 5^{th} Generation (5G) New Radio (NR), for a single component carrier (CC) in a licensed band, a UE can be configured with a single contiguous range of channel resource blocks (CRBs) for downlink (DL) or uplink (UL) transmission. The mapping of CRBs to physical resource blocks (PRBs) is determined by the UE's channel bandwidth and bandwidth part (BWP) configurations. According to a study on non-overlapping subband-wise full-duplexing in Release 18 (R18) of the 3GPP Technical Specification, a base station (e.g., gNB) can transmit and receive on non-overlapping frequency subbands in a given slot. The configuration of subbands applicable over a radio frame within the network/gNB is referred to as a subband layout. On the base station (BS) side, transmitting (Tx) and receiving (Rx) subband selectivity can reduce the DL-UL BS self-interference as well as BS-BW cross-link interferences. Nevertheless, how to enhance configuration and signaling that allow flexible scheduling of SBFD-aware UEs at a minimal cost to UE complexity remains a technique challenge. Therefore, there is a need for a solution of techniques for UE configuration and scheduling in SBFD networks.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions involving techniques for UE configuration and scheduling in SBFD networks.

In one aspect, a method may involve a UE receiving a configuration in a SBFD radio access network (RAN). The method may also involve the UE applying the configuration. In an event that the configuration comprises a DL or UL cluster configuration, the applying of the configuration comprises applying the DL or UL cluster configuration to a set of groups of RBs.

In another aspect, an apparatus implementable in an application server side network may include a transceiver and a processor coupled to the transceiver. The transceiver may be configured to communicate wirelessly. The processor may receive, via the transceiver, a configuration in a SBFD RAN. The processor may also apply the configuration. In an event that the configuration comprises a DL or UL cluster configuration, the processor may apply the DL or UL cluster configuration to a set of groups of RBs.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

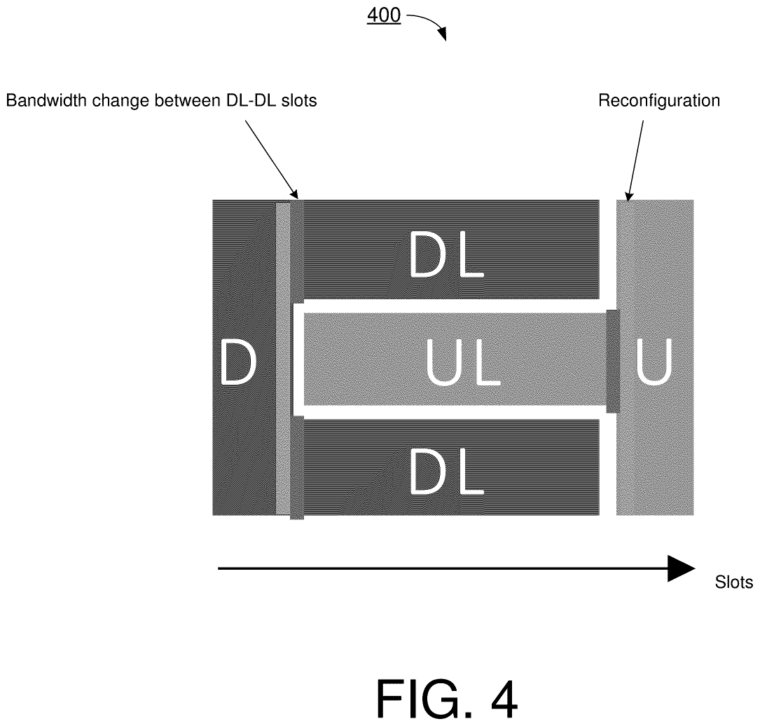

FIG. 5 is a block diagram of an example communication system in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to techniques for UE configuration and scheduling in SBFD networks. According to the present disclosure, a number of possible solutions may be implemented separately or jointly. That is, although these possible solutions may be described below separately, two or more of these possible solutions may be implemented in one combination or another.

In the present disclosure, the term “subband” or “cluster” may refer to a contiguous set of resource blocks (RBs) sharing the same link direction. The term “group of RBs” or “RB set” may refer to a set of contiguous RBs within a carrier and should be distinguished from the existing concept of “RB sets” in Release 17 (R17) of the 3GPP specification regarding New Radio unlicensed band (NR-U), which are used in wideband operation over shared spectrum. The concept of cluster availability is based on listen-before-talk in R17 while, in R18, cluster availability for sending or receiving is based on a periodic subband layout pattern. In R17, all UEs use the same cluster availability, whereas in R18, cluster configurations may be different per UE. Moreover, non-contiguous cluster operation is not allowed in R17, whereas in R18, non-contiguous cluster operation needs to be supported. Furthermore, in R18, it is assumed that there is co-existence of legacy UEs (time-division duplexing (TDD)) and enhanced UEs (SBFD-aware). The term “CLI” may refer to cross-link interference (e.g., UE/UL-to-UE/DL, gNB/DL-to-gNB/UL). The term “SIC” may refer to self-interference cancellation on the gNB side. The term “CC” may refer to component carrier in the context of carrier aggregation (CA) or multi-carrier duplexing. The term “RateMatchPattern” may refer to a concept used by the 3GPP standard to define a frequency-time region and its repetitions (called a pattern) over the network resources that are excluded from those network resources used by a DL transmission scheduled in an overlapping region. To send the same payload over less resources, the coding rate needs to be matched.

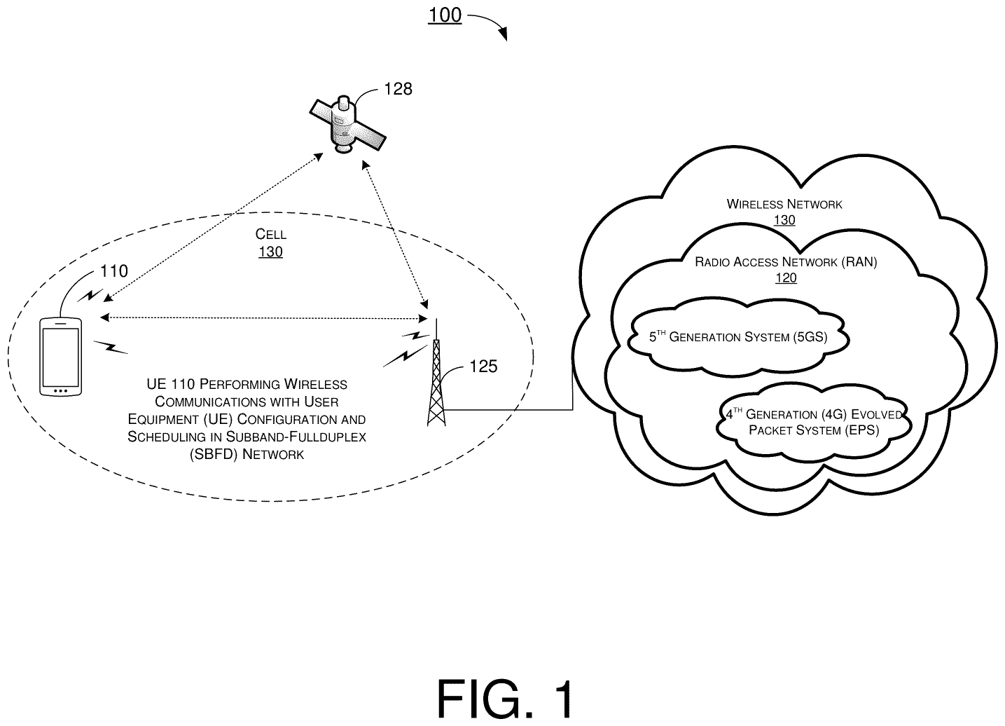

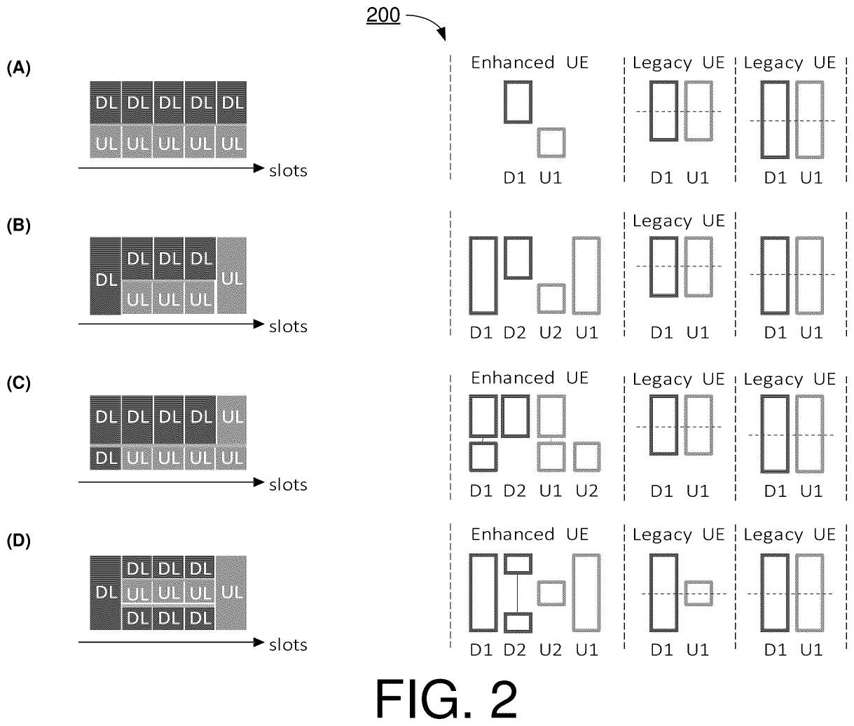

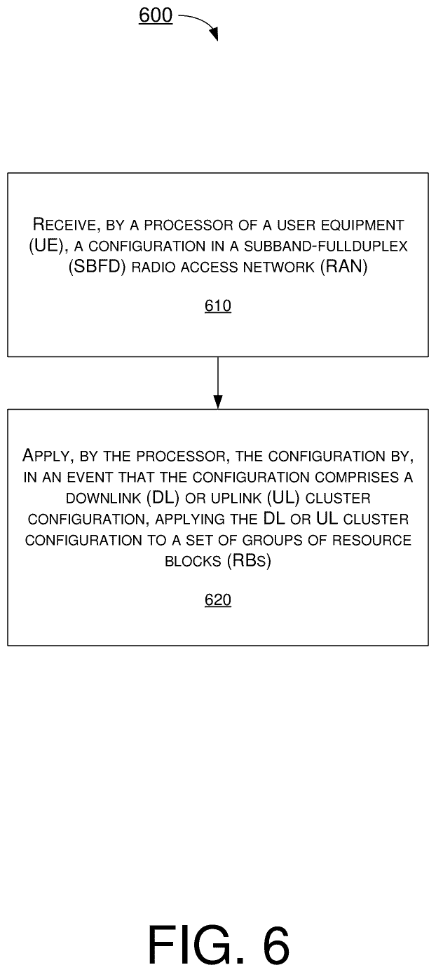

FIG. 1 illustrates an example network environment 100 in which various solutions and schemes in accordance with the present disclosure may be implemented. FIG. 2˜FIG. 6 illustrate examples of implementation of various proposed schemes in network environment 100 in accordance with the present disclosure. The following description of various proposed schemes is provided with reference to FIG. 1˜FIG. 6.

Referring to FIG. 1, network environment 100 may involve a UE 110 in wireless communication with a RAN 120 (e.g., a 5G NR mobile network or another type of network such as an NTN). UE 110 may be in wireless communication with RAN 120 via a base station or network node 125 (e.g., an eNB, gNB or transmit-receive point (TRP)). RAN 120 may be a part of a network 130. In network environment 100, UE 110 and network 130 (via network node 125 of RAN 120) may implement various schemes pertaining to techniques for UE configuration and scheduling in SBFD networks, as described below. It is noteworthy that, although various proposed schemes, options and approaches may be described individually below, in actual applications these proposed schemes, options and approaches may be implemented separately or jointly. That is, in some cases, each of one or more of the proposed schemes, options and approaches may be implemented individually or separately. In other cases, some or all of the proposed schemes, options and approaches may be implemented jointly.

FIG. 2 illustrates an example scenario 200 under a proposed scheme in accordance with the present disclosure. Scenario 200 may pertain to subband layout. Part (A) of FIG. 2 shows an example of invariant partitions with two subbands. Part (B) of FIG. 2 shows an example of two subbands with an enable pattern. Part (C) of FIG. 2 shows an example of two subbands with subband-wise dynamic time-division duplexing (DTDD) alone. Part (D) of FIG. 2 shows an example of three subbands with an enable pattern. In scenario 200, an enhanced UE (e.g., UE 110) may be aware of DL subband and UL subband, while a legacy UE may not be aware of subbands. Moreover, in scenario 200, BWP-pairs may have the same center frequency. In scenario 200 some requirements pertaining to configuration of frequency partitioning may include sensible restrictions. Moreover, configuration of time pattern when the partitioning is enabled or disabled may pertain to semi-static versus dynamic signaling as well as broadcast versus unicast versus multicast (group-common) transmissions.

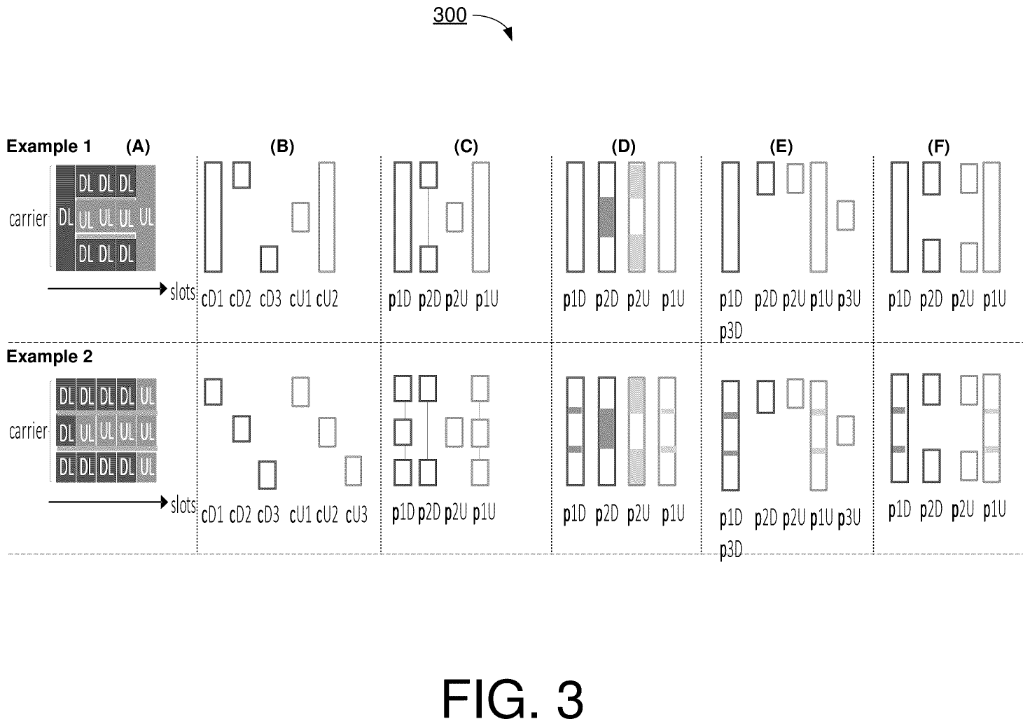

FIG. 3 illustrates an example scenario 300 under a proposed scheme in accordance with the present disclosure. Scenario 300 may pertain to two examples of subband layout. Each of parts (A)˜(F) of FIG. 3 shows a respective aspect of two examples (Example 1 and Example 2). Part (A) of FIG. 3 shows UL-DL subband layout pattern periodically repeated over slots. Specifically, part (A) of FIG. 3 shows a two-dimensional (2D) pattern over frequency-time, and it shows the non-overlapping concurrent transmissions and receptions on the BS side in each slot. Moreover, guard bands may be required for BS SIC and CLI-mitigation at least. Specific subbands in a specific slot may be left ‘flexible’. In partitioned slots, a specific UE may perform either UL or DL transmission based on semi-static or dynamic time-division duplexing (TDD) configuration. Part (B) of FIG. 3 shows individual clusters. In part (B), “C” denotes cluster, and clusters are contiguous sets of RBs that share the same link direction. It is noteworthy that the numbering of clusters is not an indicator of U-D pairs. Part (C) of FIG. 3 shows per-slot and per-symbol “partition” or “subband layout”. More specifically, part (C) shows UL and DL partitions having the same index form a pair. In part (C), “P” denotes partition. Part (D) of FIG. 3 shows one example of a solution based on RateMatchPattern. In particular, part (D) shows BWP and RateMatchPattern configuration examples for a UE with wide BWP configuration for both UL and DL transmissions. The BWP may be indicated by the straight-line and dotted frames. The UL/DL BWP does not switch, only the RateMatchPattern (bold line) region changes in DL from slot to slot. In UL, the unused regions cannot be indicated to the UE but are indicated by a light shade. Part (E) of FIG. 3 shows one example of a solution based on BWP-cluster. In part (E), p1 may be used exactly as in part (A). Here, indices may identify UL-DL pairs, BWP switching between partition p1 and p2 pairs, and p3 pairs. In the example shown, p1rD=p3D. Here, p1U has the same bandwidth as p1U, whereas p3U has a smaller bandwidth than p3D. Part (F) of FIG. 3 shows one example of CC cluster and BWP partition. Part (F) of FIG. 3 shows one example of CC cluster and BWP partition. In part (F), three cells are configured as follows: pD1supported by CC #1, pD2 supported by a combination of CC #2-#3, and CC #1 and CC #2 share the same cell defining SSB. For legacy UEs, CC #3 needs to be configured with non-cell defined synchronization signal block (NCD-SSB), e.g., period=160 ms. For legacy UEs, CC #3 needs to be configured with NCD-SSB (e.g., period=160 ms). Each partition belongs to a separate BWP, and one BWP is allocated on each slot.

Under a first proposed scheme in accordance with the present disclosure, UL and/or DL cluster configuration may be specified by a set of groups of RBs. Under the proposed scheme, only RBs in an active UL/DL BWP bandwidth may be allocated. In some implementations, a radio resource control (RRC) information element (IE) may define a set of clusters as the set of RB sets (e.g., by re-using the IE from NR-U). In other implementations, a new RRC IE may be used to defines a set of clusters. For instance, the UL and DL clusters of a DL-UL BWP pair may be configured based on a common set of groups of RBs for DL/UL, having an attribute indicating a link direction. Alternatively, UL and DL configurations may be separate as it is currently the case for RB sets.

In some implementations, a default (DL or UL) cluster configuration may be a single cluster with a group of RBs spanning an entire allocation of RBs to a (DL or UL) BWP. The default cluster may overlap with further clusters defined as part of the same BWP. In some implementations, further (DL or UL) clusters each spanning a subband of the (DL or UL) BWP may be configured to a UE (e.g., UE 110) through system information block (SIB) and semi-static RRC signaling. In some implementations, the configuration may be per group of UEs or all UEs of a cell. In one alternative, the subbands may not overlap with each other for the same UE BWP, except for the default cluster. In another alternative, the subbands may overlap with each other for the same UE BWP.

In some implementations, a guard band size of 0 may be allowed. Alternatively, the guard band size may be non-zero. In some implementations, a SIB may be used to configure clusters via RB sets applicable to all enhanced UEs. In other implementations, the SIB may configure clusters for reception via a RateMatchPattern applicable to all UEs using PDSCH-ConfigCommon. For instance, enhanced UE frontend configuration may adapt to rate match patterns by one of the following methods: (1) a flag enables adaptation to all rate match patterns; (2) a series of flags enable adaptation to each rate match pattern individually; and (3) UE frontend configuration is performed by independent means, separately from rate match patterns, which still govern resource element (RE) selection and rate matching for reception. In some implementations, enhanced UEs may be configured with a UL rate match pattern (e.g., PUSCH-ConfigCommon contains the RateMatchPattern). In some implementation, all attributes and allocations of the BWP may apply to all BWP PRBs by default (“inherited”), but specific ones may be overridden by attributes or allocations, such as PUCCH-Config, PUSCH-Config, PDSCH-Config, and so on. In one alternative, attributes and allocations may apply per partition (e.g., a combination of clusters). In another alternative, attributes and allocations may apply per cluster.

Under a second proposed scheme in accordance with the present disclosure, a combination of one or more restrictions from a list of restrictions may apply, and each restriction may be predefined or reported as a UE capability. Under the proposed schemes, the list of restrictions may include the following: (a) restriction on the number of configured DL clusters, (b) restriction on the number of DL clusters enabled in a same slot, (c) restriction on the number of configured UL clusters, (d) restriction on the number of UL clusters enabled in a same slot, (e) restriction on the number of configured DL and UL cluster combinations, (f) restriction on the number of configured non-overlapping DL and UL cluster combinations, (g) restriction on the number of DL and UL clusters combination enabled in any slot within a periodic pattern of cluster combinations, (h) restriction on the number of DL and UL cluster combinations enabled in a same slot, (i) restriction on the number(s) of time patterns with which a UE is configured, (j) restriction on the number of configured guard bands in a BWP, and (k) restriction on the number of guard bands enabled in a same slot. Under the proposed scheme, the DL and UL subband configurations may be restricted to frequency-symmetrical layouts. For instance, both DL and UL groups of RBs may be symmetrical in frequency with respect to a center frequency (e.g., the center frequency of the carrier or BWP).

Under a third proposed scheme in accordance with the present disclosure, UE 110 may be configured with a subband layout pattern according to one of the following conditions: (1) a subband partitioning is constant over all slots; and (2) the subband partitioning may vary periodically following a configured pattern. In a first option (Option-1), UE 110 may be configured with a (restricted) number of cluster combinations and with a pattern, which applies periodically over multiple slots. In some implementations, the pattern may consist of a sequence of indices each pointing to a cluster combination. Cluster combinations and their sequence may be configured by semi-static RRC configurations per cell (e.g., by SIB) or per group of UEs (e.g., by slot format indication radio network temporary identifier (SFI-RNTI)). For instance, a sub-sequence of cluster combinations may be left ‘flexible’ and selected by dynamic signalling, which may include a downlink control information (DCI) field that carries an index selecting a pattern from a predefined or semi-statically pre-configured table describing multiple patterns. In some implementations, SFI signaling and table configuration may be reused. Some of the table entries may describe combinations of TDD patterns (as in the current standard) whereas other entries may describe combinations of cluster patterns. In other implementations, SFI signaling may be reused with SI-RNTI (or a new RNTI) to look up the pattern for the ‘flexible’ sub-sequence.

In a second option (Option-2), each cluster with which UE 110 is configured may be either a DL cluster or an UL cluster. Each cluster may have a sequence of flags equal in length to the periodicity of the periodic pattern. The flag may indicate when the cluster is enabled or disabled. Additionally, only clusters with non-overlapping group of RBs may be enabled in each slot. Moreover, enabling flags may be configured by semi-static RRC configurations per cell (SIB) or per group of UEs (by RNTI), or dynamically as in Option-1.

In a third option (Option-3), a single pool of clusters may be configured that is common to UL and DL, and the direction of each cluster may be selected individually. Each cluster may have a sequence of flags equal in length to the periodicity of the periodic pattern. The flag may indicate when the cluster is enabled or disabled, and the link direction if it is enabled. Only clusters with non-overlapping group of RBs may be enabled in each slot. These flags may be configured by semi-static RRC configurations per cell (SIB) or per group of UEs (by RNTI), or dynamically as in Option-1. In some implementations, the direction flag may take a value of DL or UL. For instance, the values may be {DL, UL, Flexible}.

Under a fourth proposed scheme in accordance with the present disclosure, DTDD features may select between DL and UL BWPs in specific slots and/or symbols. That is, in case that DL or UL is configured, then this (DL or UL transmission) determines link direction with which UE 110 can be scheduled. In some implementations, SFI signaling and table configuration may be reused. Some of the table entries may describe combinations of TDD patterns (as in the current standard) whereas other entries may describe combinations of cluster patterns. In other implementations, SFI signaling may be reused with SI-RNTI (or a new RNTI) to look up the pattern for the ‘flexible’ sub-sequence.

Under a fifth proposed scheme in accordance with the present disclosure, static TDD features may be adapted to select between DL and UL directions per cluster. For instance, each cluster may have a sequence of flags, and each flag may indicate “D’ for downlink, ‘U’ for uplink, “F’ for flexible direction, or ‘X’ for disabled.

Under a sixth proposed scheme in accordance with the present disclosure, dynamic TDD features, too, may be adapted to select between DL and UL directions per cluster. For instance,

SFI signaling may be reused with system information radio network temporary identifier (SI-RNTI) or a new RNTI to look up the pattern for the ‘flexible’ subsequence using a second SFI table.

Under a seventh proposed scheme in accordance with the present disclosure, configuration of subband layout pattern over a sequence of slots may be based on sets formed of one or more UL BWPs and one or more DL BWPs. Notably, this seventh proposed scheme is an alternative to the first and second proposed schemes described above. Under the proposed scheme, each element of the pattern may select and enable, on its turn, a single UL BWP and a single DL BWP from the set over a respective slot/symbol. The BWP belonging to the same set may have the same configurations for cyclic prefix (CP) and numerology and timing advance group (TAG). Unpaired UL or DL BWPs may be part of the active set of BWPs, too. Moreover, a single cluster combination may be configured per BWP (e.g., one UL cluster combination per UL BWP and one DL cluster combination per DL BWP). In some implementations, the UL configuration may be further restricted to only contain a single cluster (as opposed to a combination of multiple clusters as in the DL). Per-slot subband layouts and set(s) of BWPs may be configured by SIB and using semi-static RRC configurations. In some implementations, multiple sets of BWPs may be configured, and a single set of BWPs may be activated by semi-static RRC configuration. In some implementations, multiple sets of BWPs may be configured, and a single set of BWPs may be activated by dynamic signaling. Switching to a fallback configuration following a time-out may be supported similarly as with the BWP switching mechanism. UE 110 may be configured with a sequence of UL-DL BWP combinations to be used as a periodically repeated pattern over subsequent slots.

Under the proposed scheme, a sub-sequence in the pattern may be left ‘flexible’ and a pattern of matching length may be selected by dynamic signaling. A DCI signal may carry the row index to the selected pattern in a semi-statically preconfigured looked-up table describing multiple patterns. Each element in the looked-up pattern may be a DL-UL BWP combination belonging to the active set of BWPs. In some implementations, the signaling may use the SFI-RNTI. An integer number carried by the group common signaling may be a vector of two indices, namely: one vector pointing to a row in the original SFI table for DTDD, and another vector pointing to a row in a second SFI table used with subband layout. In other implementations, an existing SFI signaling method may be reused with SI-RNTI, and the decoded index may be used with a second SFI table for decoding the layout. In yet other implementations, a new RNTI may be introduced for the signaling, and the decoded index may be used with a second SFI table for decoding the layout. Restrictions as in the second proposed scheme described above may apply. A one-to-one mapping may be assumed between cluster combinations and BWPs. In TDD, UE 110 may be configured with DL-UL BWP pairs having different center frequencies. In some implementations, a new DCI field may be used to select the BWP.

It is noteworthy that, regarding reconfiguration time gap, a UL-UL bandwidth switch may introduce a transition delay at BS receiver, which is non-transparent to the UE transmitter since (legacy) UE timing advance (TA) may take a single value. To avoid an UL symbol being erased during the reconfiguration delay in the BS receiver, UL repetitions may be rate matched. Under an eighth proposed scheme in accordance with the present disclosure, UFU UFFU UF . . . FU and DFD DFFD DF . . . FD type of TDD patterns for symbols may be supported (and optionally for slots as well). Additionally, RateMatchPattern may be enabled for symbols in UL transmissions. The first symbol after bandwidth change between DL-DL slots may not be used by enhanced UE for reception or measurement. Alternatively, the first symbol may be configured as an ‘F’ symbol or ‘ZP-IMR’ or with RateMatchPattern. Alternatively, the last symbol before the reconfiguration, which is not used by UE, may not be used by enhanced UE for reception or measurement. The last symbol before bandwidth change between UL-UL slots may not be used by Beyond 5G (B5G) UEs for reception or measurement. Alternatively, the first symbol may be configured as an ‘F’ symbol or ‘ZP-IMR’ or with RateMatchPattern. Alternatively, the first symbol before the reconfiguration, which is not used by the network, may not be used by enhanced UE for reception or measurement. As an option, the UE may be configured to transmit sounding reference signal (SRS) or perform UE-UE CLI measurement over the symbol not used for BS reception.

### Illustrative Implementations

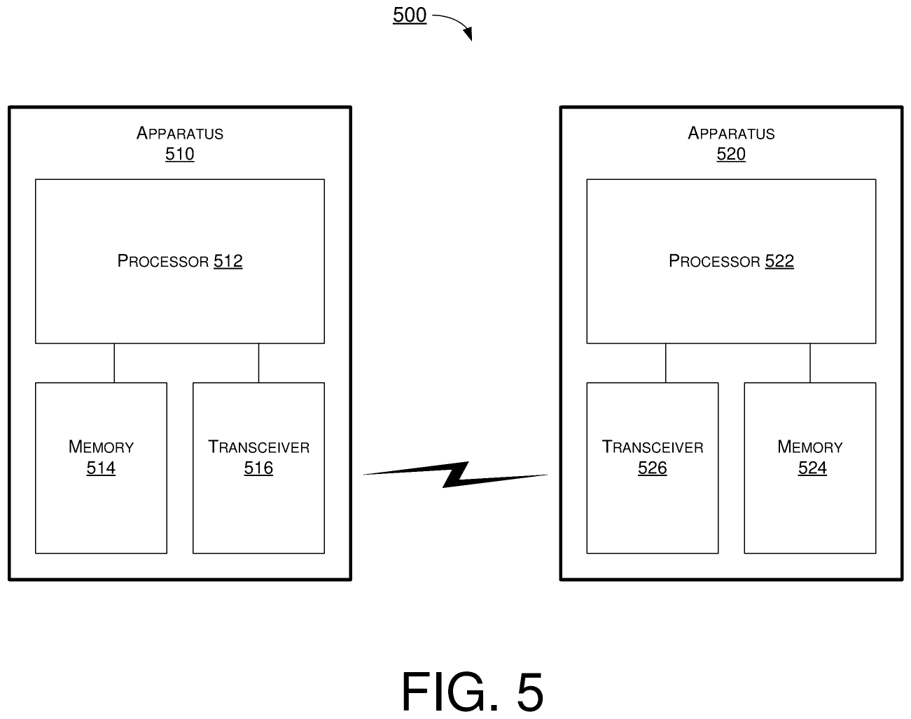

FIG. 5 illustrates an example communication system 500 having at least an example apparatus 510 and an example apparatus 520 in accordance with an implementation of the present disclosure. Each of apparatus 510 and apparatus 520 may perform various functions to implement schemes, techniques, processes and methods described herein pertaining to techniques for UE configuration and scheduling in SBFD networks, including the various schemes described above with respect to various proposed designs, concepts, schemes, systems and methods described above, including network environment 100, as well as processes described below. Each of apparatus 510 and apparatus 520 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 510 and apparatus 520 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 510 and apparatus 520 may also be a part of a machine type apparatus, which may be an IoT apparatus such as an immobile or a stationary apparatus, a home apparatus, a roadside unit (RSU), a wire communication apparatus or a computing apparatus.

For instance, each of apparatus 510 and apparatus 520 may be implemented in a smart thermostat, a smart fridge, a smart door lock, a wireless speaker or a home control center. When implemented in or as a network apparatus, apparatus 510 and/or apparatus 520 may be implemented in an eNodeB in an LTE, LTE-Advanced or LTE-Advanced Pro network or in a gNB or TRP in a 5G network, an NR network or an IoT network.

In some implementations, each of apparatus 510 and apparatus 520 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 510 and apparatus 520 may be implemented in or as a network apparatus or a UE. Each of apparatus 510 and apparatus 520 may include at least some of those components shown in FIG. 5 such as a processor 512 and a processor 522, respectively, for example. Each of apparatus 510 and apparatus 520 may further include one or more other components not pertinent to the proposed scheme of the present disclosure (e.g., internal power supply, display device and/or user interface device), and, thus, such component(s) of apparatus 510 and apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC or RISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including those pertaining to techniques for UE configuration and scheduling in SBFD networks in accordance with various implementations of the present disclosure.

In some implementations, apparatus 510 may also include a transceiver 516 coupled to processor 512. Transceiver 516 may be capable of wirelessly transmitting and receiving data. In some implementations, transceiver 516 may be capable of wirelessly communicating with different types of wireless networks of different radio access technologies (RATs). In some implementations, transceiver 516 may be equipped with a plurality of antenna ports (not shown) such as, for example, four antenna ports. That is, transceiver 516 may be equipped with multiple transmit antennas and multiple receive antennas for multiple-input multiple-output (MIMO) wireless communications. In some implementations, apparatus 520 may also include a transceiver 526 coupled to processor 522. Transceiver 526 may include a transceiver capable of wirelessly transmitting and receiving data. In some implementations, transceiver 526 may be capable of wirelessly communicating with different types of UEs/wireless networks of different RATs. In some implementations, transceiver 526 may be equipped with a plurality of antenna ports (not shown) such as, for example, four antenna ports. That is, transceiver 526 may be equipped with multiple transmit antennas and multiple receive antennas for MIMO wireless communications.

In some implementations, apparatus 510 may further include a memory 514 coupled to processor 512 and capable of being accessed by processor 512 and storing data therein. In some implementations, apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read- only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

Each of apparatus 510 and apparatus 520 may be a communication entity capable of communicating with each other using various proposed schemes in accordance with the present disclosure. For illustrative purposes and without limitation, a description of capabilities of apparatus 510, as a UE (e.g., UE 110), and apparatus 520, as a network node (e.g., network node 125 or another network node implementing one or more network-side functionalities described above) of an application server side network (e.g., network 130 as a 5G/NR mobile network), is provided below.

Under various proposed schemes in accordance with the present disclosure pertaining to techniques for UE configuration and scheduling in SBFD networks, processor 512 of apparatus 510, implemented in or as a UE (e.g., UE 110) may receive, via transceiver 516, a congestion in a SBFD RAN (e.g., RAN 120 of network 130 via apparatus 520 as network node 125). Additionally, processor 512 may apply the configuration. In an event that the configuration comprises a DL or UL cluster configuration, processor 512 may apply the DL or UL cluster configuration to a set of groups of RBs.

In some implementations, in receiving the configuration, processor 512 may receive the configuration in a RRC IE defining a set of clusters.

In some implementations, the DL or UL cluster configuration may include a single cluster with one group of RBs of the set of groups of RBs spanning an entire allocation of RBs to a DL or UL BWP.

In some implementations, in applying the configuration, processor 512 may apply DL or UL clusters each spanning a subband of a DL or UL BWP.

In some implementations, in receiving the configuration, processor 512 may receive the configuration in a SIB or via a semi-static RRC signaling. In some implementations, a GB size may be zero or non-zero.

In some implementations, in applying the configuration, processor 512 may apply a combination of one or more restrictions from a list of restrictions, and wherein the list of restrictions comprises restrictions on one or more of the following: (a) a number of configured DL clusters; (b) a number of DL clusters enabled in a same slot having the DL clusters; (c) a number of configured UL clusters; (d) a number of UL clusters enabled in a same slot having the UL clusters; (e) a number of configured DL and UL cluster combinations; (f) a number of configured non-overlapping DL and UL cluster combinations; (g) a number of DL and UL cluster combinations enabled in any slot within a periodic pattern of the cluster combinations; (h) a number of DL and UL cluster combinations enabled in a same slot having the DL and UL cluster combinations; (i) a number of time patters with which the UE is configured; (j) a number of configured GBs in a BWP; and (k) a number of GBs enabled in a same slot having the GBs.

In some implementations, in receiving the configuration, processor 512 may apply a subband layout pattern in which: (i) a subband partitioning is constant over all slots; or (ii) the subband partitioning varies periodically following the subband layout pattern. In some implementations, the UE may be configured with a number of cluster combinations and the subband layout pattern which is applied periodically over multiple slots. In some implementations, each cluster with which the UE is configured may be either a DL cluster or an UL cluster, with each cluster having a sequence of flags equal in length to a periodicity of the subband layout pattern such that each flag of the sequence of flags may indicate when a respective cluster is enabled or disabled. In some implementations, the UE may be configured with a single pool of clusters common to UL and DL transmissions, and wherein a direction of each cluster in the pool of clusters is selected individually.

In some implementations, in applying the configuration, processor 512 may apply a DTDD feature that selects between a DL BWP and an UL BWP in one or more slots or symbols.

In some implementations, in applying the configuration, processor 512 may adapt a statis TDD feature or a dynamic TDD feature to select between DL and UL directions per cluster.

### Illustrative Processes

FIG. 6 illustrates an example process 600 in accordance with an implementation of the present disclosure. Process 600 may represent an aspect of implementing various proposed designs, concepts, schemes, systems and methods described above, whether partially or entirely, including those pertaining to those described above. More specifically, process 600 may represent an aspect of the proposed concepts and schemes pertaining to techniques for UE configuration and scheduling in SBFD networks. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively in a different order. Furthermore, one or more of the blocks/sub-blocks of process 600 may be executed iteratively. Process 600 may be implemented by or in apparatus 510 and apparatus 520 as well as any variations thereof. Solely for illustrative purposes and without limiting the scope, process 600 is described below in the context of apparatus 510 as a UE (e.g., UE 110) and apparatus 520 as a communication entity such as a network node or base station (e.g., network node 125 or another network node implementing one or more network-side functionalities described above) of an application server side network (e.g., network 130). Process 600 may begin at block 610.

At 610, process 600 may involve processor 512 of apparatus 510, implemented in or as a UE (e.g., UE 110), receiving, via transceiver 516, a congestion in a SBFD RAN (e.g., RAN 120 of network 130 via apparatus 520 as network node 125). Process 600 may proceed from 610 to 620.

At 620, process 600 may involve processor 512 applying the configuration. In an event that the configuration comprises a DL or UL cluster configuration, process 600 may involve processor 512 applying the DL or UL cluster configuration to a set of groups of RBs.

In some implementations, in receiving the configuration, process 600 may involve processor 512 receiving the configuration in a RRC IE defining a set of clusters.

In some implementations, the DL or UL cluster configuration may include a single cluster with one group of RBs of the set of groups of RBs spanning an entire allocation of RBs to a DL or UL BWP.

In some implementations, in applying the configuration, process 600 may involve processor 512 applying DL or UL clusters each spanning a subband of a DL or UL BWP.

In some implementations, in receiving the configuration, process 600 may involve processor 512 receiving the configuration in a SIB or via a semi-static RRC signaling. In some implementations, a GB size may be zero or non-zero.

In some implementations, in applying the configuration, process 600 may involve processor 512 applying a combination of one or more restrictions from a list of restrictions, and wherein the list of restrictions comprises restrictions on one or more of the following: (a) a number of configured DL clusters; (b) a number of DL clusters enabled in a same slot having the DL clusters; (c) a number of configured UL clusters; (d) a number of UL clusters enabled in a same slot having the UL clusters; (e) a number of configured DL and UL cluster combinations; (f) a number of configured non-overlapping DL and UL cluster combinations; (g) a number of DL and UL cluster combinations enabled in any slot within a periodic pattern of the cluster combinations; (h) a number of DL and UL cluster combinations enabled in a same slot having the DL and UL cluster combinations; (i) a number of time patters with which the UE is configured; (j) a number of configured GBs in a BWP; and (k) a number of GBs enabled in a same slot having the GBs.

In some implementations, in receiving the configuration, process 600 may involve processor 512 applying a subband layout pattern in which: (i) a subband partitioning is constant over all slots; or (ii) the subband partitioning varies periodically following the subband layout pattern. In some implementations, the UE may be configured with a number of cluster combinations and the subband layout pattern which is applied periodically over multiple slots. In some implementations, each cluster with which the UE is configured may be either a DL cluster or an UL cluster, with each cluster having a sequence of flags equal in length to a periodicity of the subband layout pattern such that each flag of the sequence of flags may indicate when a respective cluster is enabled or disabled. In some implementations, the UE may be configured with a single pool of clusters common to UL and DL transmissions, and wherein a direction of each cluster in the pool of clusters is selected individually.

In some implementations, in applying the configuration, process 600 may involve processor 512 applying a DTDD feature that selects between a DL BWP and an UL BWP in one or more slots or symbols.

In some implementations, in applying the configuration, process 600 may involve processor 512 adapting a statis TDD feature or a dynamic TDD feature to select between DL and UL directions per cluster.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a user equipment (UE), a configuration in a subband-fullduplex (SBFD) radio access network (RAN); and
applying, by the processor, the configuration,
wherein, in an event that the configuration comprises a downlink (DL) or uplink (UL) cluster configuration, the applying of the configuration comprises applying the DL or UL cluster configuration to a set of groups of resource blocks (RBs).

2. The method of claim 1, wherein the receiving of the configuration comprises receiving the configuration in a radio resource control (RRC) information element (IE) defining a set of clusters.

3. The method of claim 1, wherein the DL or UL cluster configuration comprises a single cluster with one group of RBs of the set of groups of RBs spanning an entire allocation of RBs to a DL or UL bandwidth part (BWP).

4. The method of claim 1, wherein the applying of the configuration comprises applying DL or UL clusters each spanning a subband of a DL or UL bandwidth part (BWP).

5. The method of claim 4, wherein the receiving of the configuration comprises receiving the configuration in a system information block (SIB) or via a semi-static radio resource control (RRC) signaling.

6. The method of claim 4, wherein a guard band (GB) size is zero.

7. The method of claim 4, wherein a guard band (GB) size is non-zero.

8. The method of claim 1, wherein the applying of the configuration comprises applying a combination of one or more restrictions from a list of restrictions, and wherein the list of restrictions comprises restrictions on one or more of:
a number of configured DL clusters;
a number of DL clusters enabled in a same slot having the DL clusters;
a number of configured UL clusters;
a number of UL clusters enabled in a same slot having the UL clusters;
a number of configured DL and UL cluster combinations;
a number of configured non-overlapping DL and UL cluster combinations;
a number of DL and UL cluster combinations enabled in any slot within a periodic pattern of the cluster combinations;
a number of DL and UL cluster combinations enabled in a same slot having the DL and UL cluster combinations;
a number of time patters with which the UE is configured;
a number of configured guard bands (GBs) in a bandwidth part (BWP); and
a number of GBs enabled in a same slot having the GBs.

9. The method of claim 1, wherein the applying of the configuration comprises applying a subband layout pattern in which:
a subband partitioning is constant over all slots; or
the subband partitioning varies periodically following the subband layout pattern.

10. The method of claim 9, wherein the UE is configured with a number of cluster combinations and the subband layout pattern which is applied periodically over multiple slots.

11. The method of claim 9, wherein each cluster with which the UE is configured is either a DL cluster or an UL cluster, wherein each cluster has a sequence of flags equal in length to a periodicity of the subband layout pattern, and wherein each flag of the sequence of flags indicates when a respective cluster is enabled or disabled.

12. The method of claim 9, wherein the UE is configured with a single pool of clusters common to UL and DL transmissions, and wherein a direction of each cluster in the pool of clusters is selected individually.

13. The method of claim 1, wherein the applying of the configuration comprises applying a dynamic time-division duplexing (DTDD) feature that selects between a DL bandwidth part (BWP) and an UL BWP in one or more slots or symbols.

14. The method of claim 1, wherein the applying of the configuration comprises adapting a statis time-division duplexing (TDD) feature to select between DL and UL directions per cluster.

15. The method of claim 1, wherein the applying of the configuration comprises adapting a dynamic time-division duplexing (TDD) feature to select between DL and UL directions per cluster.

16. An apparatus implementable in an application server side network, comprising:
a transceiver configured to communicate with one or more network nodes of the network; and
a processor coupled to the transceiver and configured to perform operations comprising:
receiving, via the transceiver, a configuration in a subband-fullduplex (SBFD) radio access network (RAN); and
applying the configuration,
wherein, in an event that the configuration comprises a downlink (DL) or uplink (UL) cluster configuration, the applying of the configuration comprises applying the DL or UL cluster configuration to a set of groups of resource blocks (RBs).

17. The apparatus of claim 16, wherein the applying of the configuration comprises applying a combination of one or more restrictions from a list of restrictions, and wherein the list of restrictions comprises restrictions on one or more of:
a number of configured DL clusters;
a number of DL clusters enabled in a same slot having the DL clusters;
a number of configured UL clusters;
a number of UL clusters enabled in a same slot having the UL clusters;
a number of configured DL and UL cluster combinations;
a number of configured non-overlapping DL and UL cluster combinations;
a number of DL and UL cluster combinations enabled in any slot within a periodic pattern of the cluster combinations;
a number of DL and UL cluster combinations enabled in a same slot having the DL and UL cluster combinations;
a number of time patters with which the UE is configured;
a number of configured guard bands (GBs) in a bandwidth part (BWP); and
a number of GBs enabled in a same slot having the GBs.

18. The apparatus of claim 16, wherein the applying of the configuration comprises applying a subband layout pattern in which:
a subband partitioning is constant over all slots; or
the subband partitioning varies periodically following the subband layout pattern.

19. The apparatus of claim 16, wherein the applying of the configuration comprises applying a dynamic time-division duplexing (DTDD) feature that selects between a DL bandwidth part (BWP) and an UL BWP in one or more slots or symbols.

20. The apparatus of claim 16, wherein the applying of the configuration comprises adapting a statis time-division duplexing (TDD) feature or a dynamic TDD feature to select between DL and UL directions per cluster.
